(19) United States
(12) Patent Application Publication
(10) Pub. No.: US 2024/0392574 A1
(43) Pub. Date: Nov. 28, 2024

(54) FLEXIBLE DOWNSPOUT EXTENSION ASSEMBLY

(71) Applicant: CTW INNOVATIONS LIMITED, Calgary (CA)

(72) Inventor: Jordan Paul Robert, Calgary (CA)

(21) Appl. No.: 18/665,916

(22) Filed: May 16, 2024

Related U.S. Application Data
(60) Provisional application No. 63/504,124, filed on May 24, 2023.

(51) Int. Cl. E04D 13/08; F16L 43/00

(52) U.S. Cl. CPC E04D 13/08; F16L 43/001; E04D 2013/0813; E04D 2013/0833

(57) ABSTRACT

A downspout extension assembly includes an elbow having a first tubular body, an inlet and an outlet, the outlet at an angle of less than 180 degrees relative to the inlet, and a pair of connectors integrally formed with the first tubular body, positioned on opposite sides of the elbow's outlet. A downspout extension comprises a second tubular body having first and second ends. The first end includes a cutout in an upper wall of the second tubular body and a pair of apertures corresponding to the elbow's connectors. The elbow and the downspout extension are each manufactured of a semi-rigid, resilient material. The downspout extension is releasably mounted to the elbow by inserting a free end of each elbow connector through a corresponding aperture of the downspout extension to rotatably mount the downspout extension to the elbow. The downspout extension rotates between a storage position and a deployed position.

### FIELD

The present disclosure relates to downspout assemblies; in particular, the present disclosure relates to an improved downspout extension assembly for diverting water away from the foundation of a building.

### BACKGROUND

Whenever it rains or snows, such weather conditions produce water runoff that accumulates on the roof of a building. The water runoff may run down the sides of the exterior walls of the building and accumulate at the base of the building, if not managed properly. It is well known that collecting and diverting water runoff, so that the water drains away from the building's foundation, is important to preventing damage to the building's foundation. If water runoff from a building is allowed to collect and accumulate around the building's foundation, there is a risk that the water will cause significant damage to the building's foundation over time, which may require expensive repairs.

Typically, an eavestrough is mounted adjacent to the edge of the building's roof, the eavestrough serving to collect the water that runs off of the roof due to rain and/or melting snow or hail. The water collected in the eavestrough is then drained away from the roof, typically through a vertical channel that is in fluid communication with the eavestrough, the vertical channel referred to herein as a downspout. The downspout receives the water from the eavestrough and channels the water along the exterior wall of the building towards the base of the building. To divert the water away from the building's foundation, a downspout extension is typically attached to the outlet of the downspout, the downspout extension typically being an approximately horizontal channel that runs parallel to, or lays on top of, the ground. The downspout extension receives the water from the downspout and diverts it some distance away from the building's foundation. Often, a curved or angled connection piece, called an elbow, connects the vertical downspout to the horizontal downspout extension.

Commonly, downspout extensions are made of a length of tubing, typically made of the same thin aluminum or steel material that the downspout and eavestrough are made of. A downspout extension may be in the range of, for example, between 1 m and 5 m in length. When a greater length of downspout extension is its is required, several lengths of downspout extension pieces may be connected together to form a longer length. Typically, the downspout extension may be pivotably attached to the outlet of the downspout, or to an elbow, by a pair of screws or other fasteners, which allows the downspout extension to be rotated upwardly and away from the ground in a storage position when not in use. It is desirable to move the downspout extension out of the way when not in use; for example, because the downspout extension is often laying across grass or planters surrounding a residential or commercial building, it may be necessary to move the downspout extension out of the way to perform grass maintenance or work in the planters. Furthermore, if the area around the building is to be put to use, such as providing an area for play or socializing, it is desirable to move the downspout extensions out of the way so that they are not a tripping hazard while the area is in use. As well, it may improve the aesthetic appearance of the building when the downspout extension is in a storage position.

There are several issues with the commonly used aluminum downspout extensions. Firstly, the thin aluminum body or walls of the downspout extension is subject to damage whenever it is stepped on, driven on, hit or otherwise crushed. As the aluminum downspout extension is subjected to damage, it may be sufficiently deformed to prevent water and debris from freely flowing through the channel of the downspout extension. Furthermore, the fasteners which are used to attach the downspout extension to the outlet of the downspout may eventually tear through the aluminum walls of both the downspout elbow and the downspout extension over time, making it difficult to hold the two pieces together. Because of the frequent damage that occurs to the aluminum downspout, elbow, and downspout extension, these components need to be frequently replaced.

In addition to the commonly used downspout extensions made of thin aluminum, Applicant is aware of other types of downspout extensions. One commercially available option comprises a flexible, corrugated hose which is attached at one end to the downspout outlet. The rest of the hose is typically buried underground, thereby eliminating the need to move the downspout extension out of the way when the downspout is not in use. However, it may be costly and time consuming to install such downspout extensions, and furthermore such downspout extensions require frequent maintenance and upkeep, including the removal of leaves and other debris that may be carried through the downspout and the downspout extension, otherwise such debris may eventually block the downspout extension over time and thereby prevent water drainage. As well, such debris may cause ice build-up in the winter; significant ice build up, over time, may expand and crack the downspout extension, eventually requiring replacement of the downspout extension.

Applicant is also aware of a corrugated downspout extension such as described in Canadian patent no. 2,186,931 to Noble et al (the “Noble Patent”). In the Noble Patent, a corrugated, flexible tube or conduit is attached to the end of the downspout and is positioned along the ground so as to divert the water to a location away from the foundation of the building. However, the Noble Patent does not disclose any method for storing the downspout extension so that it is not laying on the ground when not in use for diverting water away from the building.

Applicant is also aware of U.S. Pat. No. 9,598,868 to Lolio, Jr. (the “Lolio Patent”). In the Lolio Patent, it is described that a silicone rubber downspout extension is friction fitted over the outlet of an existing downspout elbow. Similarly, Canadian patent no. 2,417,622 to Currie et al (the “Currie Patent”) discloses a rubber downspout extension that is attached, at one end, to the elbow of a downspout, via either a friction fit or with the use of an adhesive. However, neither the Lolio Patent nor the Currie Patent disclose or suggest a downspout extension that is capable of being moved into a storage position so that it is out of the way when not in use.

Canadian patent number 1,169,224 issued to McDonald et al (the “MacDonald Patent”), describes a downspout extension pivotally attached, at one end, to a boot, the other end of the boot being attached to the elbow of a downspout. The pivotal attachment between the downspout extension and the boot is accomplished by means of pivot pins which extend through the walls of both the downspout extension and the boot. At the other end of the downspout, there is a pair of rubber knobs which extend inwardly from the inner surface of the downspout extension. The rubber knobs serve the function of frictionally fitting the end of the downspout extension to the outer walls of the downspout when the downspout extension is in a storage position.

### SUMMARY

In one aspect of the present disclosure, a more durable downspout extension assembly is provided. The downspout extension assembly includes both a downspout extension and a downspout elbow, which are each constructed of a resilient and flexible rubber, elastomer or a rubber-like material. The material used to manufacture the downspout extension and the downspout elbow is sufficiently rigid enough to hold its shape and position, and is also resilient enough that when it is crushed or impacted, it may deform and then spring back into its original shape when that force is removed. For example, when the downspout extension is deployed in an operating position and is laying along the ground, and the extension is stepped on or driven over, it is temporarily crushed and deformed and then springs back into its original shape without tearing or damage when the foot or tire is removed.

Advantageously, the downspout extension is pivotably attached to the outlet of the elbow, by means of a pair of connectors that are integrally formed with, and extend outwardly from, the outer surface of the elbow. Because the connectors are made of the same flexible, resilient material as the downspout extension and the elbow, and because the connectors are integrally formed with the body of the elbow, the connectors and the corresponding apertures through the walls of the downspout extension are less prone to wear and damage over time as the downspout extension is pivoted repeatedly about the pair of connectors.

The reduced wear and tear that occurs with the proposed downspout extension assembly disclosed herein is in contrast to other downspout extension assemblies of which the Applicant is aware, in which metal pins, screws, or other fasteners are typically used to pivotably attach an aluminum downspout extension to an aluminum elbow. Due to the friction of the metal fastener or pivot pin against the material of the downspout extension and elbow, around the perimeter of the respective apertures, the apertures will widen over time and complete tears through the wall of the elbow and/or the downspout extension may eventually form, rendering the downspout extension incapable of being pivotably connected to the elbow unless new apertures are formed. In contrast, by using durable, flexible, resilient connectors which are integrally formed with the outer surface of the elbow, the apertures of the downspout extension through which the connectors are rotating wears more slowly over time, providing for a more durable and longer-lasting downspout extension assembly.

In one aspect of the present disclosure, a downspout extension assembly for attaching to an existing downspout of a building is provided. In some embodiments, the assembly comprises an elbow, the elbow comprising a first tubular body defining an angled hollow channel, the first tubular body having an inlet and an outlet such that the outlet is positioned at an angle of less than 180 degrees relative to the inlet and a pair of connectors protruding from, and integrally formed with, an exterior surface of the first tubular body. The pair of connectors are located adjacent to the outlet of the elbow and each connector of the pair of connectors is positioned on opposite sides of the elbow's outlet. The assembly also comprises a downspout extension, the downspout extension comprising a second tubular body defining a linear hollow channel having first and second ends. The first end includes a cutout in an upper wall of the second tubular body and a pair of apertures, each aperture of the pair of apertures passing through first and second side walls of the second tubular body, the pair of apertures corresponding to the pair of connectors of the elbow. The elbow and the downspout extension are each manufactured of a semi-rigid, resilient material. The downspout extension is releasably mounted to the elbow by inserting a free end of each connector of the pair of connectors of the elbow through a corresponding aperture of the pair of apertures of the downspout extension to rotatably mount the downspout extension to the elbow. When the downspout extension is rotatably mounted to the elbow, the downspout extension rotates about a rotational axis extending between the pair of connectors and the pair of apertures to move the downspout extension between a storage position that is adjacent and substantially parallel to the downspout of the building, and a deployed position that is substantially perpendicular to the downspout of the building.

In some embodiments, the angle between the inlet and the outlet of the elbow is selected from a group comprising: 90 degrees, 120 degrees, 150 degrees. In some embodiments, the connector includes an elongate post and a stop at the free end of the post. A diameter of the corresponding aperture of the downspout extension is less than a width of the stop and greater than a width of the post. In some embodiments, the post has a circular cross-section.

In some embodiments of the assembly, the outlet of the elbow and the first end of the downspout extension each have a square cross-section. In other embodiments, the outlet of the elbow and the first end of the downspout extension have a circular cross-section.

In another aspect of the present disclosure, the tubular body of the elbow includes a ribbed section located between the inlet and the outlet. The ribbed section comprises a plurality of substantially parallel ribs extending around the first tubular body. In some embodiments, the first tubular body of the elbow includes a pleated section located between the inlet and the outlet. In some embodiments, the inlet of the elbow is sized to slide onto, so as to mount onto, an outlet of the downspout of the building. In some embodiments, the elbow includes at least two apertures passing through the first tubular body and positioned adjacent to the elbow inlet, the two apertures sized to receive corresponding fasteners for fastening the elbow to the downspout. In some embodiments of the assembly, an interior surface of the first tubular body is smooth. In some embodiments, the assembly further comprises one or more extenders, each extender of the one or more extenders comprising a third or subsequent tubular body defining a linear hollow channel having first and second ends, the first end of the extender attachable to the second end of the downspout extension by a deformable sleeve. The one or more extenders are each manufactured of a semi-rigid, resilient material.

### BRIEF DESCRIPTION OF THE DRAWINGS

FIG. 1 is a perspective view of an embodiment of a downspout elbow, in accordance with the present disclosure.

FIG. 2 is a front profile view of the downspout elbow of FIG. 1.

FIG. 3 is a perspective view of an embodiment of a downspout extension pivotably attached to a downspout elbow, with the downspout extension in a deployed position.

FIG. 4 is a side profile view of the downspout extension and downspout elbow of FIG. 3, with the downspout extension in a storage position.

FIG. 5 is a perspective view of an embodiment of a downspout extension, in accordance with the present disclosure.

FIG. 6 is a top profile view of the downspout extension and downspout elbow pivotably connected to one another, with the downspout extension in a deployed position.

### DETAILED DESCRIPTION

The downspout extension assembly disclosed herein includes both an elbow component and a downspout extension component, where both components are made of a strong, resilient, flexible material, which returns to its original shape after force has been applied to it. Preferably, such material is also resistant to damage by weather, UV rays, hail damage, and other types of damage that may occur due to people vehicles and/or tools coming into contact with the downspout extension component and/or the elbow component of the assembly. Because such material is resilient and springs back into its original shape after deforming, the downspout extension assembly disclosed herein is less susceptible to damage and may have a longer useful life as compared to the typical aluminum downspout assemblies that are commonly used in both residential and commercial construction.

In particular, and unlike other flexible or resilient downspout extensions of which the Applicant is aware, the provision of a flexible, resilient elbow and a pivotable coupling between the flexible, resilient elbow and a flexible, resilient downspout extension allows for the downspout extension to be moved between a storage position and a deployed position. In the storage position, the downspout extension is kept off of the ground and out of the way of people or tools who may be using the ground next to the building. In some uses of the downspout extension assembly disclosed herein, the use of such assemblies may reduce the risk of injury. For example, a risk of injury is presented to children who may be playing in an outdoor area in the vicinity of downspout extension assemblies, which injuries may occur if the children trip over the downspout extension. In the case of conventional downspout extension assemblies manufactured of aluminum, the components may include sharp metal edges that may cut a child when handled. Advantageously, the downspout extension assemblies disclosed herein are made of a flexible, resilient material which does not include sharp edges, and because the downspout extension piece is flexible and resilient there is a reduced risk of injury if a child steps on or trips over the extension. Furthermore, as compared to other flexible downspout extensions which lay along the ground and do not have a pivotable coupling for storing the downspout extension away from the ground, the assemblies disclosed herein, which do include a pivotable coupling, allow for the downspout extension to be stored in a vertical position when not in use, thereby removing a tripping hazard.

As will be known to the person skilled in the art, a variety of different materials may be used to manufacture the flexible, resilient downspout extension assembly of the present application. For example, not intending to be limiting, natural rubber or a rubber-like material may be used to manufacture the downspout. Other examples of materials that may be suitable include silicone rubber, silicone polymers, elastomers, ethylene propylene diene terpolymer (EPDM), thermoplastic elastomers (TPE) including, for example, thermoplastic polyurethane (TPU), and any other suitable material as would be known to a person skilled in the art. In some embodiments, the components may be manufactured via extrusion and/or moulding processes, including but not limited to injection moulding. For example, the elbow component may be moulded, and the downspout extension may be moulded or extruded. In other embodiments, one or more of the components may be manufactured via 3D printing, using thermoplastic elastomers, such as thermoplastic polyurethanes for example. In a preferred embodiment, the material or materials used to manufacture the assembly components is a chemically stable, non-leaching material that will not leach compounds into the environment via the runoff water that is captured and diverted through the downspout extension system disclosed herein.

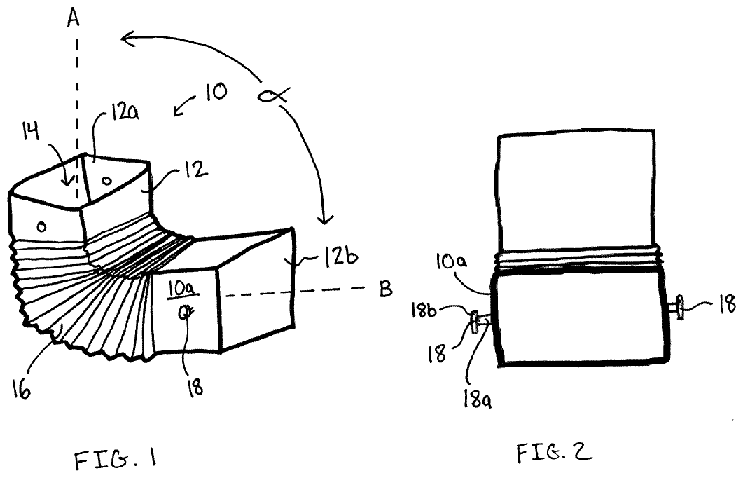

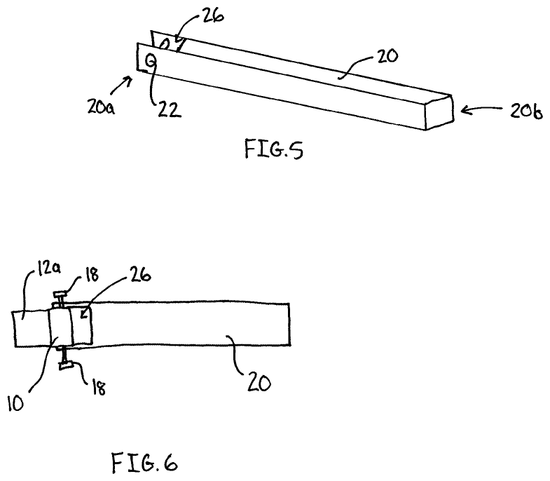

Without intending to be limiting, examples of embodiments of the assembly will now be described, with reference to FIGS. 1 to 6. Referring to FIGS. 1 and 2, the elbow component 10 comprises a tubular body 12 that defines an angled, hollow channel 14. The tubular body 12 has an inlet 12a and an outlet 12b. As best viewed in FIG. 1, a central axis A passes through the inlet 12a, and the central axis B passes through the outlet 12b. An angle α between the inlet axis A and the outlet axis B may be, for example, approximately 90°, as is the case in the illustrated embodiment of FIG. 1. However, it will be appreciated that other angles α may be appropriate, depending on how close to the ground the elbow component 10 is and the length L of the downspout extension component 20.

In some embodiments, such as the one shown in FIGS. 1 and 2, the elbow 10 may include a pleated section 16 located between the inlet 12a and the outlet 12b. The pleated section 16 may advantageously provide for enhanced flexibility in the elbow component. For example, the outlet 12b of the elbow 10 may be twisted in a plane that is perpendicular to the central axis A of the inlet. Advantageously, this flexibility in the elbow component 10 allows for the elbow to flex and bend when impacted, without causing damage to the component. In some embodiments (not shown), rather than having a pleated section 16, there may be a ribbed section located in between the inlet 12a and the outlet 12b. The ribbed section may include a plurality of ribs extending around the circumference or perimeter of the tubular body 12. The plurality of ribs throughout a ribbed section thus provides for alternating thicker and thinner portions of the wall of the tubular body 12, extending through the angled portion of the elbow 10. The ribbed structure allows for the thinner portions of the wall to more easily deform upon impact, while the thicker portions of the wall, corresponding to the ribs, allows for the angled portion of the elbow to maintain its shape. Such a structure may, similar to the pleated section 16, allow for greater deformation and freedom of movement about central axis A whenever the elbow is impacted, without causing damage to the elbow 10.

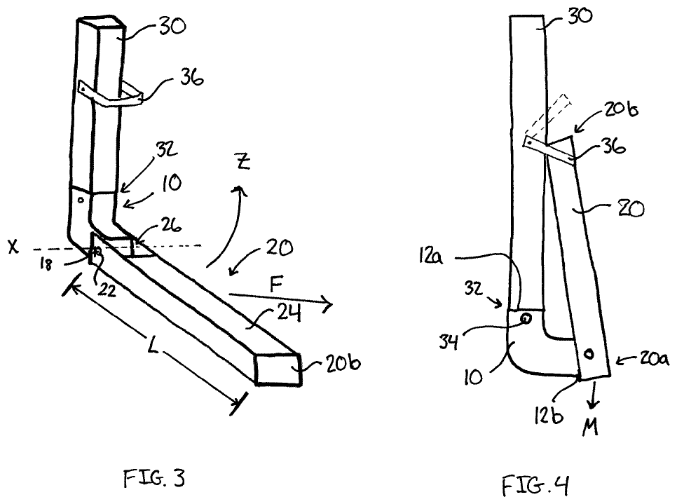

As best viewed in FIG. 2, the elbow component 10 also includes a pair of connectors 18. The pair of connectors 18 extend or protrude orthogonally from an external surface 10a of the tubular body 12. As shown in FIG. 2, the pair of connectors 18 extend from the exterior surface 10a on opposite sidewalls of the tubular body 12. Each connector 18 includes a post 18a and a stop 18b. A width of the post 18a is smaller than a width of the stop 18b. As best viewed in FIGS. 3, 5 and 6, the connector 18 is inserted through a corresponding aperture 22, the aperture 22 positioned adjacent to a first end 20a of the downspout extension 20. Because the connectors 18 are made of the same material as the rest of the elbow 10, which material is resilient and deformable, the width of the aperture 22 may be smaller than the width of the stop 18b, and larger than the width of the post 18a. Thus, the stop 18b may be squeezed and temporarily deformed to fit through the aperture 22, and then the aperture 22 surrounds the post 18a. Thus, once the downspout extension 20 is mounted to the elbow 10, the downspout extension 20 pivots about rotational axis X in direction Z. Therefore, the downspout extension 20 may be moved from a deployed position, as shown in FIG. 3, to a storage position, as shown in FIG. 4.

The elbow 10 is mounted to the outlet 32 of the downspout 30, such as shown in FIGS. 3 and 4. In some embodiments, the inlet 12a of the elbow 10 is sized so as to snugly fit over the outlet 32 of a conventional, existing downspout 30, which may typically be constructed of aluminum, or any other suitable material. The building's existing downspout 30 receives the elbow portion 10. In some embodiments, to further secure and fasten the elbow 10 to the downspout 30, the elbow 10 may additionally be secured by one or more fasteners 34, such as a screw, bolt or other suitable fastener. The building's existing downspouts 30 may additionally be provided with an existing strap 36, or else a strap 36 may be pivotably mounted to the existing downspouts 30. Thus, the downspout extension 20 may be secured in the storage position by means of the strap 36, such as illustrated in FIG. 4.

The downspout extension 20 may typically comprise a linear tubular body 24. The linear tubular body 24 may include a notch or cut out 26 that is cut into the upper portion or upper wall of the tubular body 24, adjacent the first end 20a of the downspout extension 20. As best viewed in FIG. 4, this notch 26 enables the pivoting, in direction Z, of the downspout extension 20 when it is mounted to the outlet 12b of the elbow 10. Furthermore, water may drain in direction M through the open space between the elbow outlet 12b and the first end 20a of the downspout extension 20 when the downspout extension is in the storage position, such as shown in FIG. 4.

Advantageously, because both the elbow 10 and the downspout extension 20 are made of a resilient, deformable material, which springs back to its original shape after it has been deformed, when a lateral force is applied to the downspout extension 20, for example in direction F, because both the elbow 10 and the downspout extension 20 are flexible and the connectors 18 are also flexible, the force applied in direction F may only temporarily deform and deflect the downspout extension 20 before it springs back into its approximate original shape and position. Since the elbow 10, the downspout extension 20, and the connectors 18 are all made of a flexible, resilient material, the application of a force in direction F to the downspout, or even to the elbow 10, may not result in any damage to the pivotal coupling between the elbow 10 and the downspout extension 20, nor will it cause any damage to the components themselves. Thus, the innovative downspout extension assembly disclosed herein is resistant to wear and tear that otherwise occurs as a result of normal, everyday use of a conventional downspout extension assembly.

Advantageously, because the assembly is manufactured of durable materials, the applicant estimates that the elbow 10 and the downspout extension 20 may last for up to 25 to 50 years without requiring replacement or repair. Contrast this to the typical aluminum downspout assembly, including an elbow and a downspout extension, whereby the regular wear and tear damage caused to the downspout extension may necessitate the replacement of the downspout extension every one to three years, once it has been damaged to the point of no longer coupling to the elbow 10, or having been crushed and deformed to the extent where water is no longer able to easily flow through the downspout extension 20. Furthermore, this may also advantageously extend the life of the elbow component 10, in contrast to a conventional elbow component made of aluminum, which may typically need to be replaced after a few years when the screws or other fasteners that provide the pivotal connection between a aluminum downspout extension 20 and an aluminum elbow 10 inevitably causes tearing and breakage to the walls, due to the frictional forces applied by the screw or other fasteners to the apertures through the downspout extension 20 and the elbow 10. Although the Applicant anticipates that some friction may occur between the apertures 22 of the downspout extension 20 and the connectors 18 that are integrally formed with the elbow component 10, the Applicant has found that the durable, resilient materials used to manufacture the elbow and the connectors 18, as described herein, tend to cause less frictional wear and tear between the aperture 20 and the connectors 18 during pivotal movement. Furthermore, the replacement of conventional fasteners with the integrally formed connectors, which are integrally formed with the elbow component, removes the possibility of frictional damage caused by a metal fastener rubbing against the rubber-like material of the downspout extension 20 and the elbow 10.

Although the embodiments illustrated herein depict a downspout extension assembly wherein the tubular bodies of the elbow 10 and the downspout extension 20 each have a square cross-section, it will be appreciated that the assembly may include tubular bodies having other cross-sectional shapes, including but not limited to circular, rectangular or oval cross-sections. Advantageously, the materials used to manufacture the assembly components may come in a variety of colours, and the colours may, for example, be matched to the colour of the existing downspout 30, and/or the colour of the exterior surface of the building.

What is claimed is:

1. A downspout extension assembly for attaching to an existing downspout of a building, the assembly comprising:
an elbow, the elbow comprising a first tubular body defining an angled hollow channel, the first tubular body having an inlet and an outlet such that the outlet is positioned at an angle of less than 180 degrees relative to the inlet and a pair of connectors protruding from, and integrally formed with, an exterior surface of the first tubular body, the pair of connectors located adjacent to the outlet of the elbow and each connector of the pair of connectors positioned on opposite sides of the outlet,
a downspout extension, the downspout extension comprising a second tubular body defining a linear hollow channel having first and second ends, the first end including a cutout in an upper wall of the second tubular body and a pair of apertures, each aperture of the pair of apertures passing through first and second side walls of the second tubular body, the pair of apertures corresponding to the pair of connectors of the elbow,
wherein the elbow and the downspout extension are each manufactured of a semi-rigid, resilient material, and
wherein the downspout extension is releasably mounted to the elbow by inserting a free end of each connector of the pair of connectors of the elbow through a corresponding aperture of the pair of apertures of the downspout extension to rotatably mount the downspout extension to the elbow, and
when the downspout extension is rotatably mounted to the elbow, the downspout extension rotates about a rotational axis extending between the pair of connectors and the pair of apertures to move the downspout extension between a storage position that is adjacent and substantially parallel to the downspout of the building, and a deployed position that is substantially perpendicular to the downspout of the building.

2. The assembly of claim 1, wherein the angle between the inlet and the outlet of the elbow is selected from a group comprising: 90 degrees, 120 degrees, 150 degrees.

3. The assembly of claim 1, wherein each connector includes an elongate post and a stop at the free end of the post, and wherein a diameter of the corresponding aperture of the downspout extension is less than a width of the stop and greater than a width of the post.

4. The assembly of claim 3, wherein the post has a circular cross-section.

5. The assembly of claim 1, wherein both the outlet of the elbow and the first end of the downspout extension have a square cross-section.

6. The assembly of claim 1, wherein both the outlet of the elbow and the first end of the downspout extension have a circular cross-section.

7. The assembly of claim 1, wherein the first tubular body of the elbow includes a ribbed section, the ribbed section located between the inlet and the outlet, wherein the ribbed section comprises a plurality of substantially parallel ribs extending around the first tubular body.

8. The assembly of claim 1, wherein the first tubular body of the elbow includes a pleated section located between the inlet and the outlet.

9. The assembly of claim 1, wherein the inlet of the elbow is sized to slide onto, so as to mount onto, an outlet of the downspout of the building.

10. The assembly of claim 9, wherein the elbow includes at least two apertures passing through the first tubular body and positioned adjacent to the elbow inlet, the two apertures sized to receive corresponding fasteners for fastening the elbow to the downspout.

11. The assembly of claim 7, wherein an interior surface of the first tubular body is smooth.

12. The assembly of claim 8, wherein an interior surface of the first tubular body is smooth.

13. The assembly of claim 1, wherein the assembly further comprises one or more extenders, each extender of the one or more extenders comprising a third or subsequent tubular body defining a linear hollow channel having first and second ends, the first end of the extender attachable to the second end of the downspout extension by a deformable sleeve; and
wherein the one or more extenders are each manufactured of a semi-rigid, resilient material.
